(19) United States
(12) Patent Application Publication
(10) Pub. No.: US 2007/0280405 A1
(43) Pub. Date: Dec. 6, 2007

(54) Data Transmission Means

(75) Inventors: Nils Krumme, Feldafing (DE); Stephan Lindorfer, Muenchen (DE); Ulrich Bertl, Peiting (DE)

Correspondence Address: DAFFER MCDANIEL LLP, P.O. BOX 684908, AUSTIN, TX, 78768, US

(73) Assignee: Schleifring und Apparatebau GmbH, Fuerstenfeldbruck (DE)

(21) Appl. No.: 11/738,608

(22) Filed: Apr. 23, 2007

(30) Foreign Application Priority Data
Apr. 24, 2006 (DE) 102006019323.7
Nov. 15, 2006 (DE) 102006054128.6

(51) Int. Cl. H01P 1/06

(52) U.S. Cl. 378/4

(57) ABSTRACT

A rotating data transmission device for transmitting data from a data source to a data sink between a rotating part and a stationary part comprises a transmitting conductor arrangement fed by a transmitting means, and also a receiving means for tapping signals from the transmitting conductor arrangement with the aid of a receiving coupler arrangement. A control unit controls the data source or the transmitting means so that a specific resynchronization signal is emitted in the case of an interference with reception, or an unlocking of the PLL of the receiving means.

### PRIORITY CLAIM

This application claims priority to German Patent Application 10 2006 019 323.7 filed Apr. 24, 2006, now abandoned, and German Patent Application 10 2006 054 128.6 filed Nov. 15, 2006.

### BACKGROUND OF THE INVENTION

1. Field of the Invention

The invention relates to a data transmission system for transmission of data between a rotating part and a stationary part, in particular between the rotating part and the stationary part of a computer tomograph, and also to a computer tomograph having a corresponding transmission system.

With rotatable units such as radar installations, or also with linearly movable units such as crane and conveyor systems, it is necessary to transmit electrical signals or energy between units that are movable relative to each other. For this, usually a conductor structure is provided in the first unit, and a corresponding tap in the second unit. In the following explanations the term conductor structures refers to all conceivable forms of conductor structures which are suitable for conducting electrical signals. The same also applies to contacting slide tracks or slip rings, as known. For a transmission by means of rotating data transmission devices, or linear “sliding conductor lines” that also may be designed to be non-contacting, the small distance of transmission between the units that are movable relative to each other is of importance. Thus, a signal may be coupled out optionally with galvanic contact or without contact in a near field of the conductor structures.

2. Description of Related Art

A device for data transmission in computer tomographs is known from U.S. Pat. No. 6,433,631. A transmission signal is applied to a strip conductor line in the rotating part. A tap is provided on the stationary part to be moved along at a small distance of an order of magnitude of about 1 mm from the strip conductor line. A coupling factor of the signal between both units depends substantially upon the distance of the two units from each other. Particularly with spatially extending transmission systems, and especially at high speeds of movement, the distances between the movable units cannot be set as exactly as desired because of mechanical tolerances. In practice they may vary within a range from direct contact up to a distance of few centimeters, preferably between 0.01 mm and 10 mm. Therefore the coupling factor frequently varies with the position of the two units with respect to each other, the speed (which for example causes vibration), and other influential parameters. At the same time, the signal amplitude at the input of the receiver changes. Similarly, attendant changes of resistance to interference will result. Thus, with especially low signal levels at the receiver input, and/or with interferences, an interruption of transmission may occur. Here, for example, a transition between various conductor segments of the conductor structure is especially critical.

Similar problems may arise with optical transmission systems. An example of an optical rotating data transmission system that may preferably be used in computer tomographs is disclosed in EP 1476969.

The interference with transmissions described here has different effects according to its duration. If only single bits or data words have been interfered with by short-term interference signals, they can be mainly restored by an integrated error correction of the data path. Long-term interference, or also failures in which a multitude of data words have been interfered with, may lead to a PLL (phase-locked loop) of a receiver becoming unlocked. In a case such as this, no data transmission is possible immediately after the interference has abated until the PLL has again locked-in and the receiver has been synchronized to the data stream. The duration of the resynchronization depends upon the dimensioning of the PLL, and typically lasts for several milliseconds. With data rates of several gigabytes per second, several megabytes of data may become lost before resynchronization.

### BRIEF SUMMARY OF THE INVENTION

It is the object of the invention to present a data transmission system with which regular interference with transmission may be tolerated more easily, and which leads to lower losses of data.

In accordance with the invention, this object is achieved by a rotating data transmission device for transmitting data between a rotating part and a stationary part, in which one of the parts comprises:
at least one data source;
at least one transmitting means for receiving data from the data source and emitting at least one of electric and optical signals; and
a transmitting conductor arrangement fed by the transmitting means for carrying signals along at least one given region of the rotating part;
a respective other part comprises:
   a receiving coupler arrangement for tapping-off signals from the transmitting conductor arrangement;
   at least one receiving means for receiving signals from the receiving coupler arrangement;
   at least one data sink for evaluating or further processing data supplied by the receiving means; and
   wherein at least one of the at least one receiving means and the at least one data sink comprises a PLL for temporal synchronization with the received signals; and
wherein a control unit is provided which in case of at least one of an interference with reception by the at least one receiving means, and an unlocking of the PLL, controls at least one of the at least one data source and the at least one transmitting means so that a specific resynchronization signal is emitted.

### BRIEF DESCRIPTION OF THE DRAWINGS

In the following, the invention will be described by way of example, without limitation of the general inventive concept, with the aid of examples of embodiment and with reference to the drawings:

FIG. 1 schematically shows in a general form a computer tomograph;

FIG. 2 schematically shows the arrangement of transmitting/receiving means; and

FIG. 3 schematically shows the change of various bit sequences with time.

### DESCRIPTION OF PREFERRED EMBODIMENTS

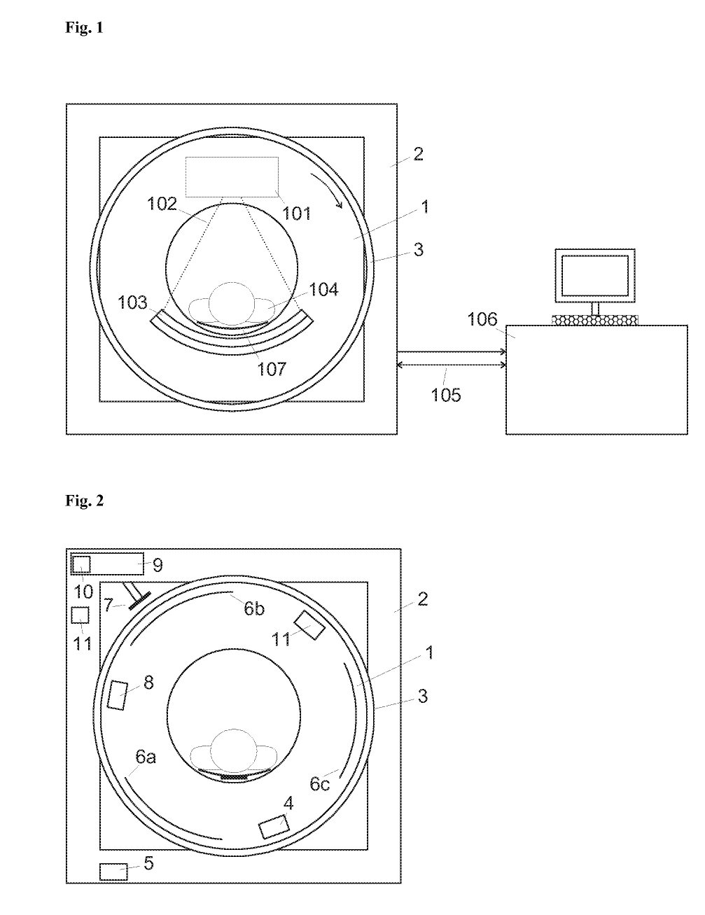

FIG. 1 shows a device in accordance with the invention, using a computer tomograph as an example. The computer tomograph (CT-Scanner) consists of two main mechanical parts. A stationary part 2 serves as a base and support of the entire instrument, within which a rotating part 1 rotates. A patient 104 is positioned on a berth 107 in an opening of the rotating part. An X-ray tube 101 as well as a detector 103 disposed opposite to it are provided for scanning the patient by means of X-rays 102. The X-ray tube 101 and the detector 103 are disposed to be rotatable on the rotating part 1. A rotary joint 3 serves for electrical connection between the rotating part 1 and the stationary part 2. With this, transmission is made, on the one hand, of high electrical power for feeding the X-ray tube 101 in the direction of the rotating part 1, and simultaneously of unprocessed image data in the opposite direction. A communication of control information in both directions is provided parallel to this. An evaluation and control unit 106 serves for operation of the computer tomograph and also for displaying the generated images. The communication with the computer tomograph is effected via a bidirectional connection 105.

FIG. 2 shows in a simplified form an example of an arrangement of a computer tomograph in accordance with the invention, which comprises the components needed for transmission. The data from a data source 4 (detector 103 with subsequent signal processing or DAS) on the rotating part 1 are processed by means of a first transmitting means 8 and relayed to the transmitting conductor arrangement which here, by way of example, is illustrated to be of three parts 6a, 6b, 6c. This transmitting conductor arrangement now carries the high-frequency signals. These are tapped off by the receiving coupler arrangement 7. Illustrated by way of example is a receiving coupler arrangement that is firmly joined to the stationary frame. The signals intercepted by this receiving coupler arrangement 7 are relayed to a first receiving means 9 for processing. The output signals from this are then conducted to a data sink 5. This figure shows by way of example the PLL in the receiving means 9. A PLL could just as well be provided alternatively or additionally in the data sink 5.

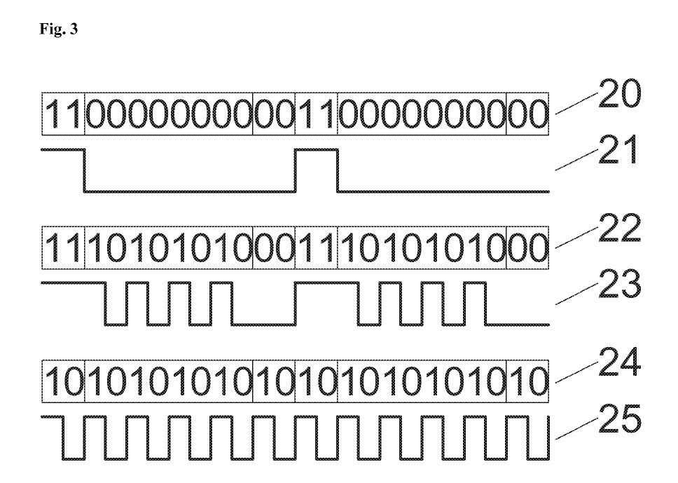

FIG. 3 shows the change of various bit sequences with time. The bit sequence 20 shows two data frames, each having two successive bits 11 at the beginning of the frame, 8 data bits 00000000 for the wanted data, and two bits 00 at the frame end, which may represent a check sum, for example. The digital signal resulting from this is illustrated by curve 21. A signal of this kind may occur during a normal data transmission. In prior art the signal would continue to be transmitted following a transmission error. It is relatively difficult for the PLL in the receiving means to synchronize with a signal of this kind and to reconstruct the bit timing for individual bits. The sequence 22 shows a resynchronization signal in accordance with an embodiment of the invention. In this, the bits at the beginning of the frame and the end of the frame remain unchanged. A bit sequence having as many 1-0 transitions as possible is transported in the frame itself. Here this is, for example, 10101010. The signal resulting from this is illustrated by curve 23 and shows substantially more transients than the signal 21. The bit sequence 24 shows a further improvement. Thus, exclusively alternating bits 1 and 0 are transmitted here. In this, a maximum number of transients, i.e. transitions from 0 to 1 or from 1 to 0, in the signal 25 is attained. In this, however, the frame structure is no longer discernible, which may possibly lead to a signaling of errors. Therefore, when a signal of this kind is being used, the PLL is advantageously switched over to a signal having a frame structure such as that, for example, of curve 23, shortly before the nominal period of synchronization has been attained.

Optionally, the features illustrated in the examples of embodiment may be applied to optical, electrical, or other transmission media and, furthermore, are independent of the number of channels to be transmitted.

A device in accordance with the invention for transmission of data (rotating data transmission device) is illustrated here, using a computer tomograph as an example. Data are transmitted between a rotating part 1 and a stationary part 2 of a computer tomograph. At least one data source 4 is provided on the rotating part and at least one data sink 5 on the stationary part. A data source may be, for example, an X-ray detector 103 or its DAS (Data Acquisition System), or also any other desired control means, or a computer. Data from a plurality of data sources may be combined with each other for transmission. A data sink may be a computer 106 for evaluating and preparing the data, but also another control unit.

The rotating data transmission device has as its most important components in the rotating part at least one first transmitting means 8 and also a transmitting conductor arrangement 6 fed thereby. A first transmitting means of this kind receives data from the data source and converts them for transmission by the transmitting conductor arrangement. The transmitting conductor arrangement comprises at least one conductor for guiding electromagnetic waves, which is preferably mounted along at least one circular segment or a circular track on the rotating part. The transmitting conductor arrangement may comprise, for example, mechanical slip-rings, non-contacting electrical coupling elements such as inductive or capacitive coupling elements, or also light waveguides. Similarly, the transmitting conductor arrangement may comprise a combination of a plurality of different coupling elements.

Furthermore, the rotating data transmission device comprises in the stationary part at least one first receiving means 9, and for feeding this, also a receiving coupler arrangement 7.

The couplers are designed to match the transmitting conductor arrangement. Thus, for example, capacitive coupler surfaces may be used together with a strip conductor structure as a transmitting conductor arrangement. Similarly, optical prism couplers may also be used together with a light waveguide such as, for example, a mirror trench as a transmitting conductor arrangement.

The receiver means converts the signals received by the receiving coupler arrangement 7 from the transmitting conductor arrangement 6 for relay to the data sink.

The receiving means 9 and/or the data sink 5 have a PLL 10 for synchronizing the internal receiver clock with the received data stream. Furthermore, a control unit 11 is provided for controlling the at least one data source 4 and/or the at least one transmitting means 8. The control unit may be on any one of the parts rotatable relative to each other, or also split-up to be on both parts. An interference with reception by the receiving means, and/or an unlocking of the PLL, is signaled by the control unit, and an emission of a specific resynchronization signal is triggered. For this, the resynchronization signal may be generated optionally by the data source which emits data especially suited for resynchronization. Similarly, the transmission means also may generate the resynchronization signal independently from the data supplied by the data source. Even when a resynchronization signal is generated instead of wanted signals supplied by the data source, no additional loss of data results, because in no case can data be transmitted with a non-synchronized PLL.

The here described, particularly advantageous embodiment of a computer tomograph is usable, with appropriate modification, also for other applications of transmission of signals from a data source to a data sink that is rotatable or linearly movable relative thereto. Examples of use are rotary joints in general, as employed in radar installations, rotary transfer machines, or cranes.

With an emission of a resynchronization signal in accordance with the invention, which minimizes the resynchronization time of the PLL, and at least shortens it with respect to the normal data, the recovery time following interference with or interruption of the transmission path can be substantially improved, and data losses can be minimized.

In accordance with prior art, even in a case of heavy interference or interruption, the wanted signals (data) continue to be transmitted. As soon as the interference has ceased and an undisturbed reception is again possible, the PLL in the receiving means will attempt to synchronize with the received data stream. If at that time wanted data are being transmitted, which have for example long sequences of 0 or 1, then a resynchronization is possible only with difficulty, and takes a relatively long time. If, contrary to this, the data have many 0-1 or 1-0 transitions, then the basic clock rate is rapidly discernible for the PLL, and a resynchronization is possible within a short time. Thus, in prior art the resynchronization time strongly depends upon the actually transmitted wanted data. In accordance with the invention, this is shortened by a specific resynchronization signal. In this respect, the invention does not relate to pure resynchronization, such as that following an interruption of operation, but also to a synchronization that is necessary, for example, when the installation is started-up. The term resynchronization has been here chosen to distinguish from a synchronization in running operation during a transmission of valid data.

Now in accordance with the invention, signals are transmitted which allow a resynchronization of the PLL within a shorter or a shortest possible time. If it happens that wanted date are being transmitted, then they are replaced by specific signals for resynchronization. This replacement leads to no additional data losses, because wanted data can in no case be transmitted during a resynchronization. In a comparison with prior art, substantially fewer data become lost, because the resynchronization can now be considerably shortened by the invention. The emission of the resynchronization signal may be effected for a given period of time, but also for the duration of a definite number of bits. It is of advantage for the duration of the resynchronization signal to be chosen so that it is slightly less than the typical synchronization period of the PLL. Thus, data may be again transmitted with a minimum of data loss as soon as the PLL has become locked-in. The terms “locked-in” or “synchronized” are here used synonymously when referring to a PLL.

A control unit in accordance with the invention also may be designed so that it triggers an emission of resynchronization signals also during a first start-up following a switching-on of the arrangement.

In another advantageous embodiment, a signaling means is provided by means of which the receiving means notifies the transmitting means or the control unit of a failure of synchronization. The notification may be effected, for example, via another contacting or non-contacting transmission path in an opposite direction to that of the data path according to the invention.

Another advantageous embodiment of the invention consists in the transmitting means or the control unit being designed to detect errors of synchronization. A detection of this kind may be effected, for example, by an absence of a confirmation, or an absence of an acknowledgement signal from the receiver.

In another embodiment of the invention, the receiver is designed to identify the synchronization signals. An identification of this kind may be effected, for example, by an evaluation of the header or the frames. Identified synchronization signals are identified as being an invalid data set, or specially evaluated.

In a particularly advantageous embodiment of the invention, the resynchronization signal has data words with as many 1-0 and/or 0-1 transitions as possible. With this, a resynchronization can be achieved within a short time. Thus, the range available for transmission of wanted data is completely filled with a sequence 0-1-0-1 . . . or 1-0-1-0 . . . in which 1 always follows 0, and 0 follows 1.

In another advantageous embodiment, the resynchronization signal consists of a continuous data stream having data frames with as many 1/0 and/or 0/1 transitions as possible. With this, also as far as possible, the frame or check sum information may be configured correspondingly. Thereby a resynchronization may be achieved in an even shorter time. However, because of invalid data, errors may be indicated by the receiving means. This error indication corresponds to the actual condition according to which no data can be transmitted because the PLL has not yet been synchronized.

In another advantageous embodiment, the resynchronization signal consists of a continuous data stream having a series of alternating 1 and 0. With this, a resynchronization may be achieved in the shortest possible time. Because here no attendant data frames are being transmitted, errors may be similarly indicated by the receiving means.

Another advantageous embodiment of the invention consists of specific data words being transmitted that represent specific control words in the communication log. These may be unequivocally distinguished from the data normally transmitted, and therefore also identified as being resynchronization signals. Here too, the specific data words should have as many 1/0 or 0/1 transitions as possible.

In another advantageous embodiment of the invention, data words representing communication errors such as frame errors or even check sum errors in the communication log are transmitted as resynchronization signals. With this too, an unequivocal identification of the resynchronization signals is possible.

The emission of the resynchronization signal may be effected optionally according to time, the number of transmitted bits, or a control signal from the receiving means or its PLL signaling a locked-in state.

Another embodiment of the invention provides at least one buffer memory for intermediate storage of received data, with the aid of which data losses in transitions or commutating operations between various receivers can be prevented. An intermediate memory of this kind makes it possible to store single bits or even large data packages, as may be the case.

A rotating data transmission device according to the invention can now be operated with data at a nominal data rate that is lower than the desired data rate. Thus, an operation at ½, 1/3 or ¼ or even other fractions of the nominal data rate is now possible. According to prior art, in such cases the transition density for resynchronization of a PLL in the receiver would be insufficient. With a resynchronization signal in accordance with the invention, at least one succession of transitions (0/1 or 1/0 transitions) that is of maximum density at the employed data rate can now be transmitted. This then makes substantially better resynchronization conditions available for the PLL.

In another embodiment of the invention, in a case of operation at a data rate which is lower than that desired, a resynchronization signal with a higher data rate corresponding to a multiple, preferably a whole number multiple of the actual data rate, and ideally with the desired data rate, can also be emitted. Here it is not yet necessary, especially in the synchronization phase, for the receiver to evaluate correct data, which also would not be possible because of the increased data rate for the receiver.

A method according to the invention for transmitting data via a rotating data transmission device or a linear sliding contact track relates to an emission of specific resynchronization signals when the PLL of the receiver is not synchronized, or following an interference of reception.

A computer tomograph in accordance with the invention comprises at least one of the rotating data transmission devices as described here.

In the present document, reference is made to a transmission from the rotating part to the stationary part of a computer tomograph in order to simplify the illustration. Of course, a device in accordance with the invention may be employed also in the opposite transmission direction. Similarly, a device in accordance with the invention may be made use of also in other applications for rotating data transmission, and similarly for linear transmission between two units that are movable relative to each other.

In general, a direction of transmission from a rotor to a stator corresponds to the most frequent case of use. However, a transmission in the opposite direction, or even bi-directionally, is equally possible.

For the sake of overall clarity of illustration, no distinction is made in this document between a transmission between units that are movable relative to each other, and between a unit that is stationary and units that are movable relative thereto, because this is only a question of reference to locality and has no bearing upon the manner of operation of the invention.

What is claimed:

1. A rotating data transmission device for transmitting data between a rotating part and a stationary part, in which one of the parts comprises:
at least one data source;
at least one transmitting means for receiving data from the data source and emitting at least one of electric and optical signals; and
a transmitting conductor arrangement fed by the transmitting means for carrying signals along at least one given region of the rotating part;
a respective other part comprises:
a receiving coupler arrangement for tapping-off signals from the transmitting conductor arrangement;
at least one receiving means for receiving signals from the receiving coupler arrangement;
at least one data sink for evaluating or further processing data supplied by the receiving means; and
wherein at least one of the at least one receiving means and the at least one data sink comprises a PLL for temporal synchronization with the received signals; and
wherein a control unit is provided which in case of at least one of an interference with reception by the at least one receiving means, and an unlocking of the PLL, controls at least one of the at least one data source and the at least one transmitting means so that a specific resynchronization signal is emitted.

2. The rotating data transmission device according to claim 1, wherein the resynchronization signal comprises data words containing, instead of wanted data, data sequences 0-1-0-1 . . . or 1-0-1-0 . . . in which values 0 and 1 always occur alternately.

3. The rotating data transmission device according to claim 2, wherein parts of data frames such as check sums are included in the date sequences.

4. The rotating data transmission device according to claim 3, wherein the resynchronization signal comprises a continuous data stream with a succession of alternately 1 and 0.

5. The rotating data transmission device according to claim 1, wherein the resynchronization signal comprises data words which represent specific control words in a communication log.

6. The rotating data transmission device according to claim 1, wherein the resynchronization signal comprises data words which represent communication errors such as frame errors, or check sum errors, in a communication log.

7. The rotating data transmission device according to claim 1, wherein the resynchronization signal is emitted at a data rate that is increased with respect to a nominal data rate.

8. The rotating data transmission device according to claim 7, wherein the resynchronization signal is emitted at a data rate that is a whole number multiple of the nominal data rate.

9. The rotating data transmission device according to claim 1, wherein the at least one given region of the rotating part is in the form of at least one circular segment or a circular track.

10. A method for transmitting data via rotating data transmission device or a linear sliding contact track, comprising an emission of specific resynchronization signals when the PLL of the receiver is not synchronized, or following interference with reception.

11. A computer tomograph, comprising a rotating data transmission device according to claim 1.
